(19) United States
(12) Patent Application Publication
(10) Pub. No.: US 2006/0246201 A1
(43) Pub. Date: Nov. 2, 2006

(54) Process for preparation of shelf stable fruit spread with no added sugar

(75) Inventors: Mysore Narayan Rekha, Karnataka (IN); Ramesh Yadav Avula, Karnataka (IN); Attar Singh Chauhan, Karnataka (IN); Ramesh Shyam Ramteke, Karnataka (IN)

Correspondence Address: ARENT FOX PLLC, 1675 BROADWAY, NEW YORK, NY, 10019, US

(73) Assignee: Council of Scientific and Industrial Research of Insdoc Building, New Delhi (IN)

(21) Appl. No.: 10/536,611

(22) PCT Filed: Dec. 20, 2002
(86) PCT No.: PCT/IB02/05554

§ 371 Date: Apr. 28, 2006

(30) Foreign Application Priority Data
Nov. 29, 2002 (IN) 1199/DEL/2002

(51) Int. Cl. A23L 1/212

(52) U.S. Cl. 426/615

(57) ABSTRACT

The invention provides a process for preparing fruit spread from liquefied fruit pulps and juice concentrates without the addition of sugar, artificial sweeteners, acid, pectin and thickeners, wherein the fruit pulp is incubated with pectolytic enzyme under controlled conditions to reduce the pulp viscosity to a desired level.

### TECHNICAL FIELD

The present invention relates to a process for the preparation of shelf stable fruit spread with no added sugar.

### BACKGROUND ART

Preparation of fruit spread is one of the most important aspects of preservation of fruits. It is a widely prevalent method to utilize cull fruits, which are not suitable for fresh market. The spread prepared by this process, certainly will have good market and can meet army and civilian's requirement. The fruit spread can be used for sand-witching and also can be taken along with chapathi, dosa or similar breakfast foods to make them more appealing and appetizing. In another way the fruit spread can be consumed by spreading it over the bread slices to relish the taste. Spread is based on concentrating fruit pulps to 70% solids (° Brix)) by addition of sugar, citric acid, pectin, thickeners/emulsifiers, syrup or fruit juice concentrate followed by heat treatment. The high osmotic pressure of sugar or concentrate creates unfavorable conditions for the growth and reproduction of most species of micro-organisms like yeast, mold and bacteria responsible for spoilage of food. By this concentration method, the water activity is reduced which ultimately decreases the potential for microbial spoilage.

In the present invention the fruit juice concentrate was mainly used as a substitute for commercially available sugar without the addition of pectin, gums or other gelling agents. The fruit spread prepared by this process was found to be good in terms of color, flavor, texture, taste and overall quality. The fruit spread prepared by this invention with no added sugar is self stable even at room temperature without any adverse effect on the sensory attributes.

There is no prior report as such on the preparation of shelf stable fruit spread with no added sugar but few relevant prior reports are available with respect to fruit spread.

Reference may be made to Kraemer, L. (Kreaemer, R.), 2000. Process for manufacture of a pumpkin based fruit spread. German Federal Republic Patent Application No. DE 198 54 800 A1 (2000) [DE 19854800 (19981127). Wherein, the manufacture of a fruit spread is described, which is based on fruit flesh of pumpkin.

The main draw back of this invention is that there is no addition of fruit pulps like jack fruit, papaya, banana, mango, guava or any fruit juice concentrate.

Reference may be made to spread based on honey, candied fruits and spices-Letrouit-J, 1998, French-Patent-Application, PN: FR 2 762 968 A1. Wherein, a spread based on honey, candied fruit and spices is free from emulsifiers, thickeners or artificial flavourings. The ingredients are mixed at a temperature in the range of 22-26° C. Stability is achieved by the high sugar content and low moisture content of the ingredients.

The Main drawback of this invention is that candied fruits have been used along with spices to prepare the spread. Use of fruit juice concentrates instead of sugar has not been attempted.

Reference may be made to Sharp-SE; Antenucci-RN, McNeil-PPC Inc., 1993, United-States-Patent; U.S. Pat. No. 5,270,071, US 900643 (19920618), “Reduced calorie fruit spreads”. Wherein, a reduced calorie fruit spread has the following composition:water; fruit or fruit flavouring; sucralose high intensity sweetener; low methoxy pectin or carrageenan; carboxymethylcellulose; guar gum; and locust bean gum.

The main draw back of this process is that it uses fruit/fruit flavorings, artificial sweeteners, pectin and gum for the preparation of fruit spread. It is merely a fruit flavored spread with or without fruit content.

Reference may be made to Poullain-F, 1993, French-Patent-Application; FR 2 687 547 A1, FR 92-02196 (19920220), “Spread”. Wherein, a spread is manufactured from a homogeneous mixture of honey, fruit pulp and an additive mixture comprising a starch-based thickener with a small amount of starch-based emulsifier.

The main draw back of this process is that it is not an all fruit spread and contains starch thickeners and emulsifiers.

Reference may be made to Fruit-Belge, 1978, Meurens-J; 46 (382) 102-108, “Industrial manufacture of syrup spreads”. Wherein, syrup manufacture (from apples, pears, sugarbeet) in Belgium is reviewed, including details of modern processing (washing, steam-cooking, juice extraction by press and centrifugation). 1000 kg fruit yields 1000 l. juice and 100-140 kg residual pulp which is used for cattle feed. Approx. 20% of the juice is left as raw syrup when vapor is drawn off. This is concentrated, cooled and put into containers (of 250-900 g) under vacuum at 18 degree C. Retail syrup is made from (i) 65% apple and pear +35% crystallized sugar (optionally with added dates, figs or raisins), (ii) 80% sugar beet and 20% apple, or (iii) pure fruit syrup (apple and pear). Total sugar content is 60% for each of the 3.

The Main drawback of the above process is that it is a syrupy spread with or without sugar or dry fruits. It is merely a juice concentrate of fruits.

Reference may be made to Unilever Ltd. 1973, British Patent-PN: 1 318 614 (1318614), “Fruit spreads”. Wherein, Food spreads comprise dispersions made from edible oils or fats and sugar syrups containing uncooked whole or divided fruit previously preserved by contact with the syrup.

The Main drawback of the above process is that it is a fat based spread which also uses sugar syrup.

Reference may be made to Unilever Nev., 1970, Netherlands-Patent-Application, PN: 7 0009 236 (70009236), “Method for the preparation of a fruit-containing sandwich spread”, Wherein, whole or comminuted fruit, e.g. raisins, currants, bilberries, and dates, are contacted for greater than 20 min with a sugar syrup (545% by wt. sugar) without cooking. The pasteurized fruit-syrup mixture is then emulsified with an edible oil or fat, which has been cooled, worked with scrapers and aerated. The product has improved stability.

The main drawback of above process is that it has edible oil or fat as an ingredient. It is not an all fruit spread.

Reference may be made to Adeva-L V; Gopez-M D; Payumo-E M, 1968, “Studies on the preparation of banana spread’. Wherein, Banana spread was prepared from each of 3 varieties of bananas, namely, bungulan, lakatan and gloria. Ripe sound bananas were made into puree, and sodium metabisulphite and other ingredients were added. The mixture was cooked in a double boiler to a thick consistency, poured into previously sterilized bottles, and processed for 30 min before complete sealing. Periodic determination of pH, total soluble solids, TS, SO2 content, colour, bacterial count and acceptability in terms of flavour and eye appeal were made up to a period of 6 months. There was no significant difference in acceptability at 1% level between the 3 samples even after 6 months of storage. From the above study it may be concluded that banana is a good material for making fruit spread. It retains its natural flavour and aroma even up to a storage period of 6 months at room temp.

The main draw back of the above process is that the product is made with banana puree and sodium Meta-bisulphite, which is suggested as spread.

Reference may be made to “Eldridge-KE; Linteris-LL, 1970, Gelled flavoured spread”. Wherein, fat is dispersed throughout a liquid fruit preserve stock and the composition gelled to provide a homogeneous non-separating spread.

The main drawback of the above process is that is fat based for fruit preserve prepared by using gelling agents.

Reference may be made to Weihofen-J, 1984, German-Federal-Republic-Patent-Application PN: DE 32 36 762 A1 (DE3236762A1), “Jam-like sweet spread made from fruit and fruit juice concentrates”.

Wherein, Jam-like spread is prepared from fruit and fruit juice concentrates which have a low content of flavouring substances and fruit acids, e.g. conc. juices of apples, pears or grape. White sugar, other types of sugar, sugar replacers and sweeteners are not used in the products.

The main drawback of above process is that the spreads are prepared from low acid concentrates, which shows they have used partially concentrated juices only. They have not used enzyme-liquefied pulps and also the juice concentrates of 68° Brix and above.

Reference may be made to Susan E., Somerset, N.J.; Robert N., Hamilton, N.J. 1992. Reduced calorie fruit spreads. U.S. Pat. No. 5,270,071. Wherein, reduced calorie fruit spread comprising the gelled product of: water, fruit or fruit flavoring, sucralose high intensity sweetener, low methoxy pectin or carrageenan, carboxymethylcellulose, guar gum and locust bean gum. A fruit spread having not more than 9 calories per teaspoon, said fruit spread comprising the gelled product of water, fruit or fruit flavoring, sucralose high intensity sweetener, low methoxy pectin or carrageenan gelling agent, carboxymethylcellulose, guar gum and locust bean gum.

The main drawback of this invention is that there is addition of gelling agents and artificial agent which shows that the product contains very less fruit content. The product contained artificial sweetener.

Reference may be made to Ned, Batavia, N.Y. 14020, 1974. High fructose corn syrup jellies and method for manufacture thereof. U.S. Pat. No. 3,892,871. Wherein, the invention relates to Edible flavored jellies, such as fruit jellies, are made from corn syrup which includes at least 15% of high fructose content corn syrup, flavor, preferably natural fruit flavor, gelling agent, preferably pectin or modified pectin, and acidifying agent, e.g., citric, phosphoric, malic, tartaric or other suitable acid or mixture of such acids. The jellies made may have sugar solids and flavor contents lower than ordinary jellies, with no loss of product quality. The finished product is stable, resistant to syneresis, even at low pH's and is of improved appearance (glossier), spreadability and “mouth feel”. It may be made more efficiently and at lower cost, compared to ordinary jelly making processes, by utilizing a short cook in an open kettle. An edible flavored jelly comprising 55 to 67% of corn syrup solids, of which at least 15% is from high fructose corn syrup, a flavoring material, 0.2 to 5% of a gelling agent, an acidifying agent in sufficient quantity to make the pH of the jelly in the range of 1.5 to 3.5, and water.

The main drawback of this invention is that they have not made any jam like fruit spread but they have prepared high fructose corn syrup jellies with the addition of high fructose corn syrup, flavoring material, gelling agents and acidifying agents. They have not used any fruit juice concentrate for the preparation of fruit jellies but high fructose corn syrup was used for the preparation of edible flavored jellies like fruit jellies.

Reference may be made to Ronald J., Greenhills, Ohio; James C., Forest Park, Ohio; 1988. Improved margarine compositions/containing solid sucrose polyesters U.S. Pat. No. 5,017,398. Wherein, bread spread compositions (e.g., margarine) wherein the fat portion of the composition comprises a triglyceride oil or a non-digestible oil and a solid non-digestible sucrose polyester of a mixture of short chain and long chain saturated carboxylic aids, the molar ratio of short chain: long chain radicals being from about 4:4 to about 3:5 and the degree of esterification being from about 7 to about 8. Bread spread comprising about 50% to 90% mixture consisting essentially of: (i) an edible oil selected from the group consisting of triglyceride oils and non-digestible oils, and mixtures thereof, said oil having a solid fat content of 1% or less at 50° F. and 0% at 70° F.; (ii) a solid fatty acid ester of sucrose, the fatty-acid groups consisting essentially of saturated straight chain short chain fatty acid radicals containing from 2 to 10 carbon atoms and saturated straight chain long chain fatty acid radicals containing from 20 to 24 carbon atoms, the molar ratio of short chain to long chain radicals being from about 4:4 to 3:5 and the degree of esterification being from about 7 to about 8; the weight ratio of (i) to (ii) being from about 3:1 to about 9:1; (b) from about 0.01% to about 10% of an emulsifier; (c) from about 0.5% to about 5% milk solids; (d) from about 0.5% to about 3.5% salt; and (e) the balance, water.

The main drawback of this invention is that spread is devoid of fruit pulps and fruit juice concentrate. They have prepared bread spread based on fat content comprised of triglyceride oil, non-digestible oil and a solid non-digestible sucrose polyester along with long chain saturated carboxylic acids.

Reference may be made to Okonogi-Shigeo, Tokyo, Japan: Yuguchi-Hiroya, Tokyo, Japan; Tanai-Sumio, Yokohama, Japan; Morimoto-Keiji, Matsudo, Japan; 1988. Method of manufacturing jelly products having fibrous texture. U.S. Pat. No. 4,957,764. Wherein, a method of manufacturing jelly products having fibrous texture resembling fruit pulp, wherein at least a first liquid material adjusted to pH 4.0 or less and containing at least a kind of proteinous material selected from the group consisting of those originating from eggs, milk and Soya beans, and a second liquid material containing at least a kind of gum selected from the group consisting of xanthan gum, gum arabic and pullulane and at least a kind of gelling agent selected from the group consisting of agar, furcellaran, and carrageenan are separately prepared, then they are mixed at a temperature higher than the gelling temperature of the gelling agents used, and cooled for gelling. An additional liquid material including material derived from fruit and/or vegetable, for example fruit or vegetable juice, can be added to the mixture of said first and second liquid materials in such a manner that said first and second liquid materials are mixed and after fibrous textures are actually formed in the resultant mixture, the additional liquid materials are added to the mixture while it maintains its flowability. An edible jelly having improved spreadability and heat-resistance comprising a mixture of a gelling agent, sucrose flavoring, a food acid, water and finely-divided water-insoluble organic particles consisting of from 85 to 95% by weight of beta-1,4 glucan intimately associated with 5 to 15% by weight of sodium carboxymethyl cellulose having a degree of substitution of 0.75±0.15, said organic particles constituting at least about 0.5% of the weight of the mixture.

The main drawback of this invention is that the product was not prepared by using fruit juice concentrate for the replacement of sugar, protenacious material, gum was also added.

Reference may be made to Emanual J., New Castle, Del.; Francis, H., Furlong, Pa.; 1975. Edible Jelly and method of preparing same. U.S. Pat. No. 3,947,604. Wherein, edible jelly having improved spreading characteristics and ability for withstanding heat is made by incorporating into the recipe finely-divided, water-insoluble organic particles consisting of 85 to 95% by weight of beta-1, 4 glucan intimately associated with 5 to 15% by weight of sodium carboxymethyl cellulose having a degree of substitution of 0.75±0.15.

The main drawback of this invention is that they have not used any fruit juice concentrate and gums were used for gelling for preparing the edible jelly.

Reference may be made to Albersmann; Heinz, Emmerich, Germany; 1989. Process of the preparation of fruit, vegetable or spicy aerated foods. U.S. Pat. No. 5,000,974. Wherein, Low-calorie aerated fruit, vegetable and spicy foods free of fats and albumin having improved taste, increased volume and stable structure said foods containing sugar or sugar substitutes or sweeteners, spices or fruit or vegetable extracts combined with hydro colloids and optionally suitable emulsifiers to achieve a high and stable overrun. A process for making aerated fruit, vegetable or spicy foods in the absence of fat and albumin, and having an overrun of about 70 to 150%, at a temperature of 7° to 9° C., comprising providing a fruit, vegetable or spicy food base, conveying said food base to cooling aerating means, regulating the gas flow rate and pressure introduced in said cooling aerating means and aerating and cooling the food base to thereby obtain a degree of aeration of about 70 to 150% and a temperature of the ingredients of 7° to 9° C., wherein said fruit, vegetable or spicy food is a ready-made one-component base selected form of the formulations, relative to the dry mass comprised of: approximately 20 to 70% of fruit, approximately 20 to 60% of sugar, approximately 20 to 70% of fruit, approximately 10 to 20% fructose, and effective amounts of synthetic sweeteners, approximately 20 to 70% of fruit, and effective amounts of synthetic sweeteners, approximately 20 to 50% of fruit, and effective amounts of salt and/or sugar, quantities of vegetable or fruit plant extracts, having added thereto, 0.5 to 0.8 weight percent, relative to the base, of a hydro colloid combination of the following composition: about 25% of locust-bean flour, about 25% of pectin, degree of esterification 35 to 38%, about 50% of carrageenans, and 0 to 0.08 weight percent, relative to the base, of an emulsifier.

The main drawback of this invention is that they have used synthetic sweeteners, air incorporation, emulsifiers and gelling agents for preparing the low calorie aerated foods based on fruit, vegetable and spice.

Reference may be made to Valdes; Mario A., Boston, Mass. 02120, 1989. Pipeable gelled food and ethyl alcohol beverages. U.S. Pat. No. 5,019,414. Wherein, this invention relates to food of as little caloric value as desired made into spreadable gels, ideally transparent for certain usage's and opaque for others, similar in consistency to mayonnaise or butter at room temperature. The taste release of such gels is superior to that of other products served set or molded. Such is true because the more divided or fractioned a food is the more surface area available with which the taste buds of the tongue may interact. Fruit spreads may thus be produced using less sugar or concentrate than those formulated with either pectin or gelatin. The gels are made pipeable by fractioning set gels using at least a 325-mesh sieve. After fractioning the gel is re mixed producing a pipeable gel. The invention relates to a gelled form or non-beverage form of ethyl alcohol and to the method for making gelled ethyl alcohol and to the products formed from such gelled alcohol. The method involves the addition of or the mixing of ethyl alcohol beverage products with carboxymethylcellulose (CMC) having a degree of substitution of 7. Addition of carrageenan further increased the viscosity of the product to the degree that the product becomes a set gel and is thus moldable. Gels formed using the CMC can further be made into set gels with the addition of an aluminum salt such as basic aluminum acetate (BAA) or aluminum formoacetate (AFA). Thus the non-beverage form of the alcoholic beverage product, with the addition of aluminum salt, can be made in the form of a set gel. Upon fractioning of a firm/set gel, by sieving through a fine mesh sieve, one obtains a pipeable gel i.e., one which can be dispensed through a pipe of the type used in cake decorating.

The main drawback of this invention is it is related to gelled alcoholic beverage with addition of gum and salts. There was no addition of fruit juice concentrate during the preparation of gelled alcoholic beverage.

Reference may be made to Charles H., Wooster, Ohio; Karen S., Akron, Ohio; David J., Akron, Ohio; 1992. U.S. Pat. No. 5,260,083. Fruit spread and method of preparing same. Wherein, an edible fruit spread in a form similar to a jelly or jam having improved texture and flavor characteristics and a decrease dissipation rate in the mouth during consumption is prepared by incorporating a pectin, starch, cellulose, carrageenan or protein based fat mimetic into a fruit spread recipe.

The main draw back of this invention is that gums were used for gellying of fruit spread but natural fruit juice concentrate was not used.

Reference may be made to Dianne P., Newark, Del.; 1981. Stabilized fruit suspensions and method for preparing the same. U.S. Pat. No. 4,370,354. Wherein, a fruit suspension which contains a mixture of from 70% to 30% low methoxyl pectin and from 30% to 70% xanthan based on the total weight of gum added, preferably a 50:50 mixture, is effectively stabilized. Such a mixture is particularly useful in stabilizing the fruit suspension employed in sundae style yogurts because it eliminates problems with unwanted gelatin and fruit float.

The main draw back of this invention is that it is related to the preparation of fruit suspensions stabilized with xanthan and low methoxyl pectin. There is no addition of fruit juice concentrate while preparing the stabilized fruit suspensions.

Reference may be made to, Robert N., Hamiltion, N.J.; Thomas R., Yardley, Pa.; Francois Y., Princeton Junction, N.J.; Susan E., Somerset, N.J.; 1993. Reduced calorie fruit spreads. U.S. Pat. No. 5,397,588. Wherein, a reduced calorie fruit spread comprising the gelled product of: a. water; b. fruit or fruit flavoring; c. one or more high intensity sweeteners selected from the group consisting of aspartame; saccharin; acesulfame-K; mixtures thereof; and mixtures of aspartame, saccharin, or acesulfame-K; mixtures thereof; and mixtures of aspartame, saccharin, or acesulfame-K with sucralose; d. low methoxy pectin or carrageenan; e. carboxymethylcellulose; f. guar gum; and g. locust bean gum.

The main draw back of this invention is that they have used high intensity sweeteners from the group consisting of aspartame, saccharin, acesulfame-K and mixtures thereof and also mixtures of aspartame, saccharin or acesulfame-K with sucralose. Apart from this they have not used natural fruit juice concentrate.

Reference may be made to the mixed fruit spread manufacturer M/S Hindustan Lever Ltd., Mumbai Kissan mixed fruit spread. The product was prepared by using fruit juice, honey, fruit pieces, pectin and calcium.

The draw back of the invention is the fruit concentrate was not used as a sugar source and the pectin and calcium were used for gelling the spread.

### OBJECTS OF THE INVENTION

The main objective of the present invention is to provide a process for the preparation of shelf stable fruit spread with no added sugarin another objective of the present invention is to provide a process for the preparation of all fruit spread with no added sugar and gums/gelling agents. Yet in another objective of the present invention is to provide a process for the preparation of pulp and concentrate required for the above process.

Still, yet in another objective of the present invention is to provide a process for the preparation of fruit spread from minor fruit concentrate or honey with no added sugar and gelling agents, which obviates the draw back as detailed above.

The novelty of the present invention is that the fruit spread is a unique product prepared by virtue of this invention using liquefied fruit pulp along with fruit juice concentrate (as a sugar base). Therefore, addition of sugar is not required in the present invention.

### DETAILED DESCRIPTION OF THE INVENTION

Accordingly, the invention provides a novel process for the preparation of shelf stable fruit spread with no added sugar, which comprises of:
(i) preparing fruit pulp by crushing fruits,
(ii) incubating the pulp with 0.75-1.25% pectolytic enzyme of enzyme activity 1590 units/ml of PolyGalactouronse and 17.7 units/gm of Pectin Methyl Esterase at 27-40° C. for a period of 2-4 hours at a temperature of 27-40° C. to allow pulp to liquefy and thereby lowering the viscosity of the pulp by 60-80%,
(iii) heating of the enzyme treated pulp to inactivate the enzyme with proper mixing to attain a temperature of 65-75° C. with immediate cooling at room temperature of 27-30° C., followed by filtration through muslin cloth to get strained fruit juice,
(iv) concentrating the strained fruit juice by employing vacuum evaporation using thin film evaporator at the temperature of 40-45° C. with system pressure (vacuum 22-24 inches) to obtain high total soluble solids (70-72° Brix) fruit juice concentrate,
(v) preparing a less viscous fruit pulp by crushing fruits and incubating the fruit pulp with 0.75-1.25% pectolytic enzyme of enzyme activity—1590 units/ml of Poly Galactouronse and 17.7 units/gm of Pectin Methyl Esterase at 27-40° C. for a period of 20-40 minutes to reduce the viscosity of the fruit pulp by 30-50%, and
(vi) mixing required quantity of fruit juice concentrate (20-30%) of step (in vitro fertilization) with the liquefied fruit pulp of step (v) to obtain total soluble solids content from 30-45° Brix, followed by boiling the mixture to get a fruit spread of 68-700 Brix.

In an embodiment, the fruits are selected from jack fruit, papaya, apple, banana, guava and ber. Ber (Zizyphus mauritiana Lamk) is an ancient and indigenous fruit of India, China and Malaysia region. The fruits are very nutritious and are rich in vitamin C, A & B complex. The ber is one of the most common fruit trees of India and is cultivated practically all over India.

In an embodiment of the present invention, the liquefaction of pulpy fruits may be done to the extent of 40-70% pulp viscosity reduction by the addition of pectinolytic enzyme viz. Pectinase [Enzyme activity in terms of Polygalacturonase (PG) 1590 units/ml and Pectin methylesterase (PME) 17.7 units/gm] to get the liquefied fruit juice.

In another embodiment of the present invention, the liquefied and filtered fruit juice may be subjected to vacuum concentration by using thin film evaporator at the temperature of 40-45° C. with system pressure (vacuum 22-24 inches) to obtain high total soluble solids (70-72° Brix) fruit juice concentrate.

Yet, in another embodiment of the present invention, the mixture of fruit pulp/pulps and concentrates in required proportions may be used for preparation of fruit spread of 68° Brix without any added sugar, sweeteners, pectin or gums.

Still, yet in another embodiment of the present invention, the mixture of fruit pulp/pulps and honey in required proportions may be used for preparation of fruit spread of 68° Brix without any added sugar, sweeteners, pectin or gums.

The process of the present invention involves following steps: 1. (i) Preparation of fruit pulp by crushing fruits like jack fruit, papaya, apple, banana, guava and ber. (ii) Liquefying the pulp by incubating with 0.75-1.25% pectolytic enzyme of enzyme activity 1590 units/ml of PolyGalactouronse and 17.7 units/gm of Pectin Methyl Esterase at 27-40° C. for a period of 2-4 hours at the temperature of 27-40° C. to allow the liquefaction of pulp thereby lowering the viscosity by 60-80%. (iii) Heating of the enzyme treated pulp to inactivate the enzyme with proper mixing to get 65-75° C. temperature thereafter immediate cooling at room temperature (27-30° C.) followed by filtration through muslin cloth to get strained fruit juice. (iv) The strained fruit juice is concentrated by employing vacuum evaporation using thin film evaporator at the temperature of 40-45° C. with system pressure (vacuum 22-24 inches) to obtain high total soluble solids (70-72° Brix) fruit juice concentrate. (v) Preparation of less viscous fruit pulp by crushing fruits like jack fruit, papaya, apple, banana, guava and ber followed by liquefaction of the pulp by incubating with 0.75-1.25% pectolytic enzyme of enzyme activity—1590 units/ml of Poly Galactouronse and 17.7 units/gm of Pectin Methyl Esterase at 27-40° C. for a period of 20-40 minutes to reduce the viscosity of the pulps by 30-50% thereafter, a required quantity of fruit juice concentrate (20-30%) of jack fruit, papaya or ber may be mixed with liquefied fruit pulps to get total soluble solids content of the mixture ranges from 30-45° Brix followed by boiling the mixture to get a fruit spread of 68-70° Brix.

The following examples are given by way of illustration of the present invention and should not be construed to limit the scope of the present invention. Variations and changes may be made by one skilled in the art without departing from the spirit of the invention. All parts and percentages are by weight, unless otherwise indicated.

### EXAMPLE 1

300 g of fine jackfruit pulp treated with 1% pectinolytic enzyme [Enzyme activity in terms of Polygalacturonase (PG) 1590 units/ml and Pectin methylesterase (PME) 17.7 units/gm] at RT for a period of 40 minutes to get reduction in pulp viscosity (20%). To this 100 g of jackfruit concentrate of 72° Brix′ was added which was prepared from 100 kg of fresh ripened jack fruits, subjected to cutting into four halves, removal of bulbs, sorting, deseeding bulbs and cutting of jack fruit bulbs (20 kg) into two halves thereafter subjected to fruit mill followed by colloidal mill to get fine pulp having viscosity of 1600 cps. Enzymatic treatment (1.0% Pectinolytic enzyme) for liquefaction of the 20 Kg jack fruit pulp and subjecting to incubation for the period of 2 hours at 40° C. Heating of the enzyme treated pulp at 70° C. to inactivate the enzyme thereafter cooling at room temperature (30° C.) followed by cloth filtration and centrifugation to get enzyme liquefied juice of jack fruit. The yield was 15 kg and thereafter concentrated by vacuum evaporation using thin film evaporator at the temperature of 45° C. under vacuum (24 inches). The yield of jack fruit juice concentrate was 4.2 kg of 72° B.

The mixture containing partially liquefied jackfruit pulp and concentrate in the ratio of 3:1 (30° Brix) was boiled with continuous stirring till it attained a final 68° Brix. The process resulted in 220 g of jack fruit spread with pleasant mild jack fruit flavor. The product is filled hot into pre sterilized glass bottles and stored at room temperature.

### EXAMPLE 2

300 g of fine papaya pulp was treated with 1% pectinolytic enzyme [Enzyme activity in terms of Polygalacturonase (PG) 1590 units/ml and Pectin methylesterase (PME) 17.7 units/gm] at RT for a period of 20 minutes to get reduction in viscosity (45%). 50 g of crushed raisins were added. To this 100 g of jack fruit concentrate of 72° Brix (Prepared as described in Example 1) was added and the mixture containing papaya pulp, raisins and jack fruit concentrate with 30° Brix was boiled with continuous stirring till it attained a final 68° Brix. The process resulted in 250 g of fruit spread with pleasant mild flavor. The product was filled hot into pre sterilized glass bottles and stored at room temperature.

### EXAMPLE 3

300 g of fine banana pulp was treated with 1% pectinolytic enzyme [Enzyme activity in terms of Polygalacturonase (PG) 1590 units/ml and Pectin methylesterase (PME) 17.7 units/gm] at RT for a period of 20 minutes to get reduction in pulp viscosity (35%). 50 g of crushed raisins added. 100 g of jack fruit concentrate of 72° Brix (Prepared as described in Example 1) was added and the mixture containing banana pulp, raisins and jack fruit concentrate with 35° Brix was boiled with continuous stirring till it attained a final 68° Brix. The process resulted in 260 g of fruit spread with pleasant mild flavor. The product is filled hot into pre sterilized glass bottles and stored at room temperature.

### EXAMPLE 4

100 Kg of fresh ripened cashew apples are subjected to washing, crushing and pulping in a screw type juice extractor to get 65 kg cashew apple juice of 11° brix (total soluble solids). Treatment with 0.5% gelatin for clarification for 2 hours followed by filtration through filter press to get 50 Kg of clarified cashew apple juice The clear cashew apple juice was concentrated by employing a vacuum evaporation technique using thin film evaporator at the temperature of 40° C. with system pressure (vacuum 24 inches). The yield of cashew apple juice concentrate 69° Brix was 7 kg on prepared weight basis.

300 g of fine papaya pulp was treated with 1% pectinolytic enzyme [Enzyme activity in terms of Polygalacturonase (PG) 1590 units/ml and Pectin methylesterase (PME) 17.7 units/gm] at RT for a period of 20 minutes to get reduction in pulp viscosity (45%). 50 g of crushed raisins were then added. 100 g of cashew apple concentrate of 69° Brix was added.

The mixture with an initial brix of 30° was boiled till it attained a final 68° Brix with continuous stirring. The process resulted in 250 g of fruit spread. The product is filled hot into pre sterilized glass bottles and stored.

### EXAMPLE 5

97 Kg of fresh ripened papaya fruits are subjected to washing, peeling, cutting and pulping in a pulper equipped with stainless steel sieve (mesh size 1/32″) to get fine pulp of papaya fruits having viscosity of 1300 cps and 10° brix (total soluble solids). Enzymatic treatment (1.0% Pectinolytic enzyme) for liquefaction of the 67 Kg pulp of papaya fruits thereafter subjecting to incubation for the period of 2 hours at the temperature of 40° C. to allow the liquefaction. Heating of the enzyme treated pulp at the temperature of 70° C. to inactivate the enzyme thereafter immediate cooling at room temperature (30° C.) followed by filtration through muslin cloth to get 49 Kg of enzyme liquefied papaya juice which is passed through filter press to get clear papaya juice. The clear papaya juice (40 kg) was concentrated by employing a vacuum evaporation technique using thin film evaporator at the temperature of 45° C. with system pressure (vacuum 24 inches). The yield of papaya juice concentrate was 5.5 kg on prepared weight basis.

300 g of fine mixed fruit pulp (Jack fruit:Papaya:Mango:Banana:Guava, in equal quantities i.e. 60 gm each) pulp was treated with 1% pectinolytic enzyme [Enzyme activity in terms of Polygalacturonase (PG) 1590 units/ml and Pectin methylesterase (PME) 17.7 units/gm] at RT for a period of 30 minutes to get reduction in pulp viscosity (30%). 50 g of crushed raisins were then added followed by 100 g of papaya concentrate of 70° Brix.

The mixture with initial brix of 30° x was boiled with continuous stirring till it attained a final 68° Brix. The process resulted in 240 g of fruit spread with pleasant mild flavor. The product is filled hot into pre sterilized glass bottles and stored.

### EXAMPLE 6

To 300 g of fine apple pulp was treated with 1% pectinolytic enzyme [Enzyme activity in terms of Polygalacturonase (PG) 1590 units/ml and Pectin methylesterase (PME) 17.7 units/gm] at RT for a period of 30 minutes to get reduction in pulp viscosity (30%). To this 100 g of Jack fruit concentrate of 7⁰° Brix (Example 1) was added. The mixture with initial Brix of 33° was boiled with continuous stirring till it attained a final 68° Brix. The process resulted in 220 g of fruit spread with pleasant mild flavor. The product is filled hot into pre sterilized glass bottles and stored.

### EXAMPLE 7

300 g of fine mixed fruit pulp (Jack fruit:Papaya:Mango:Banana:Guava, in equal quantities i.e. 60 gm each) was treated with 1% pectinolytic enzyme [Enzyme activity in terms of Polygalacturonase (PG) 1590 units/ml and Pectin methylesterase (PME) 17.7 units/gm] at RT for a period of 30 minutes to get reduction in pulp viscosity (30%). 50 g of crushed raisins were then added followed by 100 g of honey of 75° Brix (of reputed brand procured from local market). The mixture with initial Brix of 32° was boiled with continuous stirring till it attained a final 68° Brix. The process resulted in 220 g of fruit spread with pleasant mild flavor. The product is filled hot into pre sterilized glass bottles and stored.

The main advantages:

1. The pectinolytic liquefaction of pulpy mass of fruits envisaged in reduced viscosity thereafter passing through thin film evaporator for vacuum concentration becomes easy to obtain high total soluble solids (68-72° Brix).
2. The high degree Brix fruit juice concentrates prepared from jack fruit, papaya, cashew apple and any other suitable temperate/tropical fruit juice may be used as a base material instead of cane sugar in the preparation of fruit spread.
3. The fruit spread prepared by the present invention has excellent sensory qualities in terms of color, texture, flavor and overall quality.
4. The fruit spread prepared by the present invention has good storage stability like jam at room temperature without affecting the sensory characteristics.

1. A process for preparing fruit spread, wherein the process does not include the addition of a sugar, sweetener, pectin or gum, comprising the steps of:
(i) preparing fruit pulp by crushing fruits,
(ii) incubating the pulp with 0.75-1.25% pectolytic enzyme of enzyme activity 1590 units/ml of PolyGalactouronse and 17.7 units/gm of Pectin Methyl Esterase at 27-40° C. for a period of 20 to 40 minutes to allow the pulp to liquefy thereby lowering the viscosity of the pulp by 60-80%;
(iii) heating of the enzyme treated pulp to inactivate the enzyme with mixing to attain a temperature of 65-75° C. followed by immediate cooling to room temperature of 27-30° C. and filtration through muslin cloth to get strained fruit juice;
(iv) concentrating the strained fruit juice by employing vacuum evaporation using thin film evaporator at the temperature of 40-45° C. with system pressure vacuum 22-24 inches to obtain high total soluble solids of 70-72° Brix;
(v) incubating the fruit juice concentrate with 0.75-1.25% pectolytic enzyme of enzyme activity—1590 units/ml of PolyGalactouronse and 17.7 units/gm of Pectin Methyl Esterase at 27-40° C. for a period of 20-40 minutes to reduce the viscosity of the fruit pulp by 30-50%; and
(vi) mixing 20 to 30% of the fruit juice concentrate with the fruit pulp of step (v) to obtain a mixture having total soluble solids content from 30-45° Brix, followed by boiling the mixture to obtain a fruit spread of 68-70° Brix.

2. The process of claim 1 wherein the fruits are selected from jack fruit, papaya, apple, banana, guava, mango and Zizaphus mauritiana Lamk

3. The process of claim 1 wherein liquefaction of pulpy fruits is done to the extent of 40-70% pulp viscosity reduction by the addition of a pectinolytic enzyme.

4. The process of claim 1 further comprising the step of subjecting the fruit juice concentrate of step (v) to vacuum concentration by using thin film evaporator at the temperature of 40-45° C. with system pressure (vacuum 22-24 inches) to obtain high total soluble solids of 70-72° Brix.

5. (canceled)

6. (canceled)

7. The process of claim 3 wherein the pectinolytic enzyme comprises Pectinase, wherein the enzyme activity in terms of Polygalacturonase is 1590 units/ml and Pectin methylesterase is 17.7 units/gm.
